(19) United States
(12) Patent Application Publication
(10) Pub. No.: US 2012/0218205 A1
(43) Pub. Date: Aug. 30, 2012

(54) TOUCHSCREEN-ENABLED MOBILE TERMINAL AND TEXT DATA OUTPUT METHOD THEREOF

(75) Inventor: Sung Ryong PARK, Seoul (KR)

(73) Assignee: SAMSUNG ELECTRONICS CO. LTD., Suwon-si (KR)

(21) Appl. No.: 13/401,140

(22) Filed: Feb. 21, 2012

(30) Foreign Application Priority Data
Feb. 28, 2011 (KR) 10-2011-0017532

(51) Int. Cl. G06F 3/041

(52) U.S. Cl. 345/173

(57) ABSTRACT

A touchscreen-enable mobile terminal and a method for outputting text data in accordance with a touch gesture made to the mobile terminal are provided. The method includes displaying text data on a screen in a text output mode, detecting a touch gesture, determining whether the touch gesture is followed by a movement, and outputting, when the touch gesture is followed by the movement, a text selected among all displayed text data according to a direction of the movement. The user can select the text data to be output with a touch gesture. Also, the user can recognize the text data selected by a touch gesture in the form of a vibration or a sound output.

### PRIORITY

This application claims the benefit under 35 U.S.C. §119(a) of a Korean patent application filed on Feb. 28, 2011 in the Korean Intellectual Property Office and assigned Serial No. 10-2011-0017532, the entire disclosure of which is hereby incorporated by reference.

### BACKGROUND OF THE INVENTION

1. Field of the Invention

The present invention relates to a touchscreen-enabled mobile terminal and a text data output method thereof. More particularly, the present invention relates to a touchscreen-enabled mobile terminal and a method for outputting text data selected in accordance with a touch gesture detected on the touchscreen of the mobile terminal.

2. Description of the Related Art

A touchscreen is a device that is reactive to a touch gesture detected by a touch sensor embedded over a display. The touchscreen is provided in the majority of recently produced mobile terminals. This is because the touchscreen is easy to use and negates the need for a separate input device, especially in a compact mobile terminal.

In order to meet the diverse user requirements associated with supplementary functions and services, adoption of the touchscreen is spreading to various types of portable devices such as cellular phones and tablet computers. Such portable devices are used in various fields for various purposes due to their portability and functionality.

The touchscreen is well-matched with text data processing applications such as an electronic book (e-book) application that is increasing in popularity.

However, the conventional touchscreen-enabled mobile terminals are designed without consideration for vision-impaired persons such that a vision-impaired user cannot use the text data processing applications such as e-book applications.

Accordingly, there is a need for a touchscreen-enabled mobile terminal and method for outputting text data in response to a touch gesture made by the user.

### SUMMARY OF THE INVENTION

Aspects of the present invention are to address at least the above-mentioned problems and/or disadvantages and to provide at least the advantages described below.

In accordance with an aspect of the present invention, a data output method of a mobile terminal equipped with a touchscreen is provided. The method includes displaying text data on a screen in a text output mode, detecting a touch gesture, determining whether the touch gesture is followed by a movement, and outputting, when the touch gesture is followed by the movement, a text selected among all displayed text data according to a direction of the movement.

In accordance with an aspect of the present invention, a data output terminal is provided. The data output terminal includes a touchscreen including a display unit for displaying text data in a text output mode and a touch sensor for detecting a touch gesture, a control unit for determining whether the touch gesture is followed by movement and for selecting a text according to a direction of the movement, and a text output unit for outputting the text under the control of the control unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description in conjunction with the accompanying drawings, in which:

FIG. 1 is a block diagram illustrating a configuration of a mobile terminal according to an exemplary embodiment of the present invention;

FIG. 2 is a front view of a touchscreen-enabled mobile terminal for illustrating a principle of a text data output method according to an exemplary embodiment of the present invention;

FIG. 3 is a flowchart illustrating a method for outputting text data in a mobile terminal according to an exemplary embodiment of the present invention; and

FIG. 4 is a flowchart illustrating a movement direction-based text data output procedure according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Particular terms may be used herein to describe the invention in the best manner. However, the meaning of specific terms or words used in the specification and the claims should not be limited to the literal or commonly employed sense, but should be construed in accordance with the spirit of the invention.

In the following description, the term ‘mobile terminal’ denotes an information processing device equipped with a touchscreen for processing data input by the user. The mobile terminal can be any of a cellular phone, a tablet computer, an electronic book (e-book) reader, and their equivalents that are capable of displaying text data.

In the following description, the term ‘text data’ denotes symbols or letters for consonants and vowels of any kind of language such as Korean, English, and others. The text data can be a string of letters provided in a texting application, a word processing application, an e-book application, and the like. The text data can be composed of at least one of a character, a word, a phrase, and a sentence. Here, a letter is text data composed of one alphabet character, i.e. a consonant or a vowel. A word is text data composed of a plurality of letters and can be used independently. A phrase is composed of a plurality of words and denotes a group of words that can be bound together.

In the following description, the term ‘touch’ denotes a state where a user's finger or a stylus maintains contact with the surface of the touchscreen. The term ‘release’ denotes a state where the contact is lifted from the surface of the touchscreen.

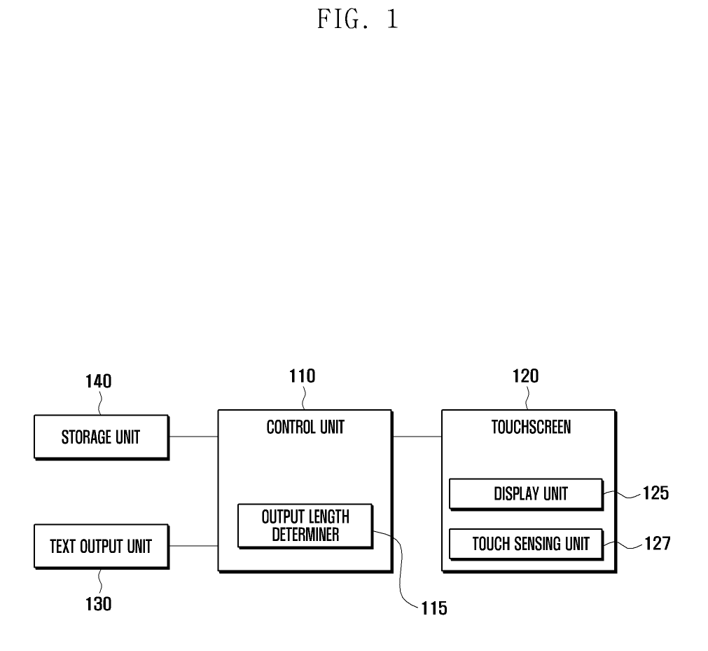

FIG. 1 is a block diagram illustrating a configuration of a mobile terminal according to an exemplary embodiment of the present invention.

Referring to FIG. 1, the mobile terminal includes a control unit 110, a touchscreen 120, a text output unit 130, and a storage unit 140.

The control unit 110 controls the operations and states of the internal functions blocks of the mobile terminal. According to an exemplary embodiment of the present invention, when a touch gesture made to one of the text data displayed on a display unit 125 is detected by the touchscreen 120, the control unit 110 outputs a vibration or a voice corresponding to a selection by the touch gesture.

The control unit 110 executes a text output mode according to the user input. The text output mode is an operation mode for displaying text data on the display unit 125 in association with the e-book reader function, text messaging function, memo function, an Internet access function, and the like. The control unit 110 controls the display unit 125 to display the text data selected by the user. That is, the control unit 110 displays the text data such as e-book text data, messaging service text data, and a document text data on the display unit 125.

The control unit 110 can control such that, when a touch gesture is detected on a text data, the text data is output in the form of a vibration signal or a voice signal according to the type of the touch gesture. For this purpose, the control unit 110 includes an output length determiner 115.

The output length determiner 115 determines the length of the text data to be output in response to the touch gesture. In more detail, the output length determiner 115 checks the direction of the touch gesture detected by the touchscreen 120 and determines whether to output a character, a word, a phrase, or all text data on the screen by means of the text output unit 130 depending on the direction of the touch gesture.

If a touch gesture is detected, the output length determiner 115 determines whether the touch gesture includes movement. If the touch gesture includes movement, the output length determiner 115 determines a direction of the movement, i.e., horizontal direction, vertical direction, or diagonal direction. At this time, the movement direction of the touch gestured can be determined based on the variation of coordinates. For example, if only the x-axis coordinate of the touch point is changed, this means that the touch gesture includes horizontal movement. Otherwise, if only the y-axis coordinate of the touch point is changed, this means that the touch gesture includes vertical movement. Furthermore, if both the x-axis and y-axis coordinates are changed, this means that the touch gesture includes diagonal movement.

The output length determiner 115 determines a unit of the text data to output by the text output unit 130, (i.e., a character, a word, a sentence, a paragraph, or all the text on the screen) depending on the movement direction of the touch gesture. That is, if the touch gesture detected by the touchscreen 120 includes the horizontal movement, the output length determiner 115 checks the text data in units of a word or a sentence around the region where the touch gesture has been made. If the touch gesture detected by the touchscreen 120 includes the diagonal movement, the output length determiner 115 checks the text data in units of a paragraph. If the touch gesture detected by the touchscreen 120 includes the vertical movement, the output length determiner 115 checks all of the text data presented on the current screen.

The control unit 110 controls such that the text data selected by means of the output length determiner 115 are output in the form of a vibration or voice signal by means of the text output unit 130. Here, the control unit 110 retrieves the vibration or voice signal mapped to the text data and outputs the retrieved vibration or voice by means of the text output unit 130. In case that the text output unit 130 outputs the text data in the form of a vibration, the vibration is output in Morse code.

The touchscreen 120 is provided with the display unit 125 and a touch sensing unit 127. The display unit 120 displays menus of the mobile terminal and information input by and/or presented to the user. The display unit 125 can be implemented with a Liquid Crystal Display (LCD). More particularly in an exemplary embodiment of the present invention, the display unit 125 can display text data on the screen under the control of the control unit 110.

The touch sensing unit 127 is formed on a surface of the display unit 125 and can detect a touch gesture made on the surface of the display unit 125. The touch sensor 127 can acquire the coordinates at the position where the touch gesture is made. The coordinates at the position where the touch gesture is made are used for determining the movement direction of the touch gesture. The touch sensing unit 127 can be implemented with one of a capacitive overlay sensor, a supersonic reflection sensor, an optical sensor, and an electronic guidance sensor.

The text output unit 130 is capable of outputting text data in units corresponding to the length determined based on the touch gesture under the control of the control unit 110. The text output unit 130 can include at least one of a vibrator and an audio processor. In case that the text output unit 130 is implemented with a vibrator, the text output unit 130 can output the text data in the form of a pattern of strong and weak vibrations under the control of the control unit 110. The text output unit 130 also can output the text data in the form of a pattern of Morse code under the control of the control unit 110. In case of using the vibration for expressing the Morse code pattern, it is assumed that the first level strength of vibration indicates a space for delimiting text data, the second level strength of vibration indicates a dot (•), and the third level strength of vibration indicates a dash (−). The text output unit 130 can output the text data in the form of Morse code expressed by the variation of the vibration strength. In case that the text output unit 130 is implemented with an audio processor, the text output unit 130 can output the text data in the form of a voice signal according to the touch gesture under the control of the control unit 110.

The storage unit 140 stores programs and data necessary for operating the function blocks of the mobile terminal under the control of the control unit 110. The storage unit 140 can store information regarding a time window used for determining whether a touch gesture is a flick gesture or a drag gesture. The storage unit 140 also can store information regarding a time window used for determining the number of paragraphs to be output according to the movement direction of the touch gesture. The storage unit 140 also can store information regarding the vibration information and voice signals mapped to respective text data for outputting the text data in the form of the vibration or voice signal.

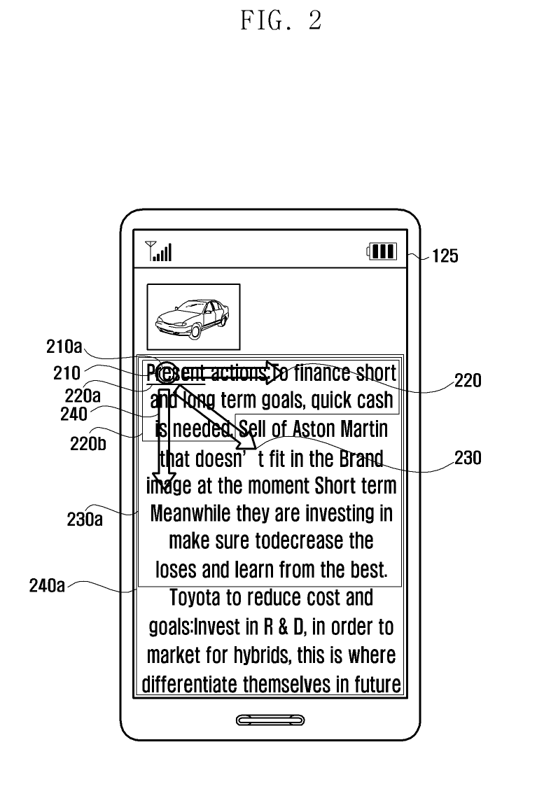

FIG. 2 is a front view of a touchscreen-enabled mobile terminal for illustrating a principle of a text data output method according to an exemplary embodiment of the present invention.

Referring to FIG. 2, in the text output mode the control unit 110 displays the text data selected by the user on the screen of the display unit 125. If a touch gesture 210 is detected on the touchscreen 120, the control unit 110 determines whether the touch gesture includes movement. If the touch gesture 210 is released without movement, the control unit 110 outputs the text data 210a mapped to the region to which the touch gesture 210 is made by means of the text output unit 130.

If the touch gesture 210 is released after the movement in the direction denoted by reference number 220, the control unit 110 determines the time duration from the time point when the touch is made to the time point when the touch is released. The control unit 110 controls the text output unit 130 to output the word 220a or the sentence 220b positioned in the region to which the touch gesture is made according to the determined time duration. If the touch gesture 210 is released after movement in the diagonal direction denoted by reference number 230, the control unit 110 controls the text output unit 130 to output the paragraph 230a including the text data mapped to the region to which the touch gesture is made. If the touch gesture 210 is released after movement in the vertical direction denoted by reference number 240, the control unit 110 controls the text output unit 130 to output the entire text data 240a displayed on the screen of the display unit 125.

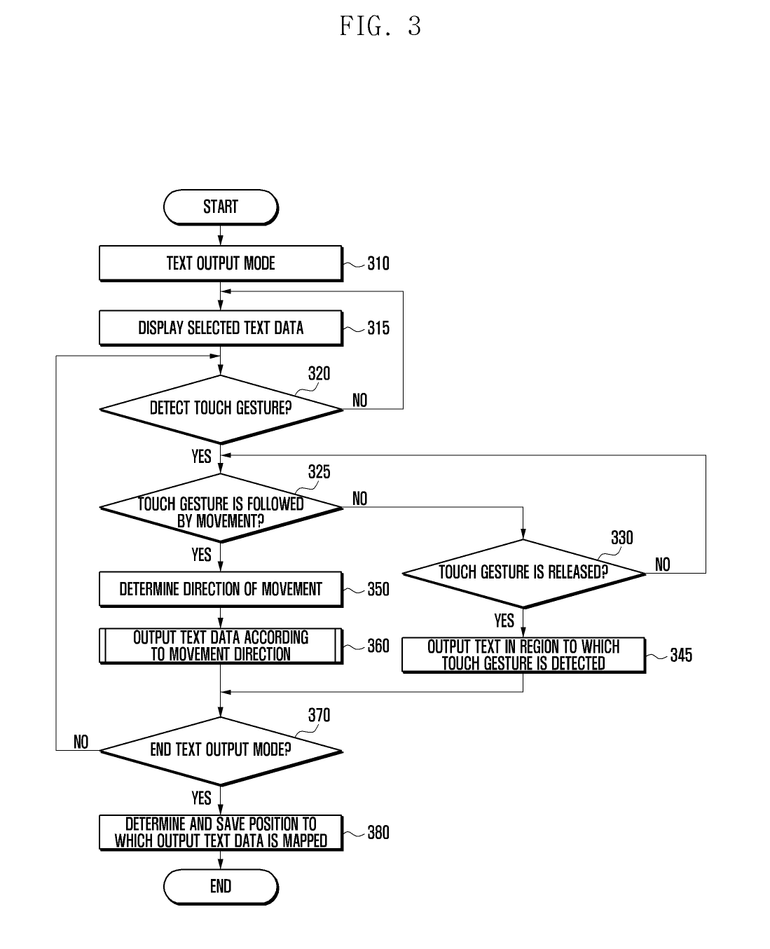

FIG. 3 is a flowchart illustrating a method for outputting text data in a mobile terminal according to an exemplary embodiment of the present invention.

Referring to FIG. 3, the control unit 110 first executes the text output mode in step 310. The text output mode is an operation mode for displaying text data on the display unit 125 in association with the e-book reader function, text messaging function, memo function, an Internet access function, and the like. The control unit 110 controls the display unit 125 to display the text data selected by the user. The control unit 110 controls the display unit 125 to display the text data selected by the user in step 315. That is, the control unit 110 controls the display unit 125 to display the text data of e-book file, a messaging service message, a document file, and the like.

The control unit 110 monitors to detect a touch gesture on the touchscreen displaying the text data in step 320. If a touch gesture is detected on the touchscreen, the control unit 110 determines whether the touch gesture is followed by movement in step 325. If the touch gesture is not followed by any movement, the control unit 110 determines whether the touch is released in step 330. If the touch is released, the control unit 110 determines the region at which the touch gesture is detected and outputs the text data mapped to the region in step 345. At this time, the control unit 110 can control the text output unit 130 to output the text data in the form of a vibration pattern corresponding to a Morse code. Although the description is directed to the case in which the text data is output in the form of a vibration pattern, the present invention is not limited thereto. That is, if the text output unit 130 is implemented with an audio processor, the text data can be output in the form of a voice signal.

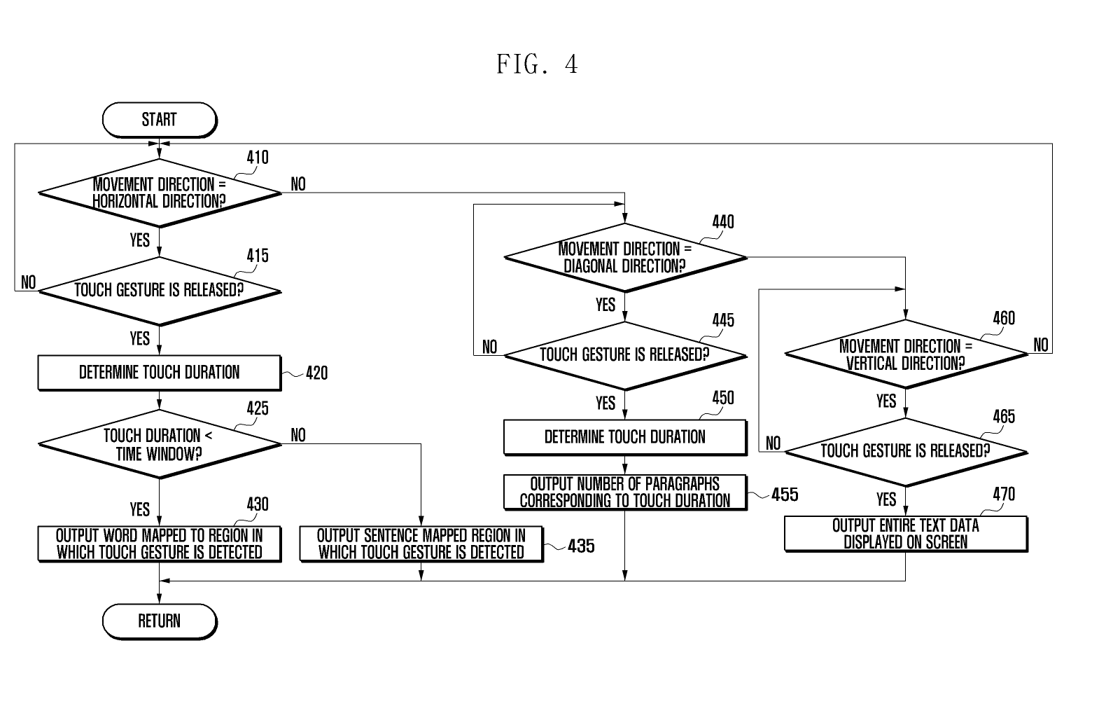

Returning to step 325, if the touch gesture is followed by movement, the control unit 110 determines the direction in which the movement is made in step 350. The control unit 110 outputs the text data selected depending on the movement direction in step 360. The movement direction-based text data output procedure is described later with reference to FIG. 4.

After output of the selected text data, the control unit 110 monitors to detect an input of the text output mode termination command in step 370. Until the text output mode termination command is detected, the control unit 110 repeats the procedure from step 320. If the text output mode termination is detected, the control unit 110 determines the position of the text data output in response to the touch gesture and saves the output text data position in the storage unit 140 in step 380. Afterword, if the text output mode is executed, the control unit 110 can notify the user of the position of the text data which is output in the previous session.

A description is made of an exemplary procedure for outputting text data selected depending on the direction of the movement following the touch gesture with reference to FIG. 4.

FIG. 4 is a flowchart illustrating a movement direction-based text data output procedure according to an exemplary embodiment of the present invention.

Referring to FIG. 4, the control unit 110 determines whether the direction of the movement following the touch gesture is the horizontal direction in step 410. If the movement direction is the horizontal direction, the control unit 110 determines whether the touch gesture is released in step 415. If the touch gesture is released, the control unit 110 determines the touch duration defined between the start time and end time of the touch gesture in step 420. That is, the control unit 110 determines the time duration taken from the time point at which the touch gesture stars to the time point at which the touch gesture is released.

The control unit 110 determines whether the touch duration is less than a predetermined time window in step 425. The time window is a time duration for differentiating between a flick gesture and a drag gesture and can be determined in the manufacturing stage of the mobile terminal.

If the touch duration is less than the time window, the control unit 110 outputs the word mapped to the region in which the touch gesture is detected in step 430. In more detail, the control unit 110 determines the text data mapped to the region in which the touch gesture is detected. The control unit 110 determines the word including the text data and outputs the text data constituting the word in the form of a vibration pattern or a voice signal by means of the text output unit 130.

Otherwise, if it is determined in step 425 that the touch duration is equal to greater than the time window, the control unit 110 outputs the sentence mapped to the region in which the touch gesture is detected in step 435. In more detail, the control unit determines the text data mapped to the region in which the touch gesture is detected. The control unit 110 determines the sentence including the word retrieved at the region in which the touch gesture is detected, retrieves the sentence including the word, and outputs the text data of the sentence in the form of a vibration pattern or a voice signal.

Returning to step 410, if it is determined that the movement direction is not the horizontal direction, the control unit 110 determines whether the direction of the movement following the touch gesture is the diagonal direction in step 440. If the movement direction is the diagonal direction, the control unit 110 determines whether the touch gesture is released in step 445. If the touch gesture is released, the control unit 110 determines the touch duration defined between the start time and the end time of the touch gesture in step 450. The control unit 110 outputs the text data of a number of paragraphs corresponding to the touch duration in the form of a vibration pattern or a voice signal by means of the text output unit 130 in step 455. In more detail, the control unit 110 determines the time duration taken from the time point at which the touch gesture starts to the time point at which the touch gesture is released. Next, the control unit 110 compares the touch duration with time windows having values that increment stepwise. The time windows are configured to indicate the different numbers of paragraphs. The control unit 110 determines the number of paragraphs based on the comparison result and outputs the text data of the paragraphs as many as determined by the touch duration in the form of a vibration pattern or a voice signal.

Returning to step 440, if the movement direction is not the diagonal direction, the control unit 110 determines whether the movement direction is the vertical direction in step 460. If the movement direction is the vertical direction, the control unit determines whether the touch gesture is released in step 465. If the touch gesture is released, the control unit 110 outputs all text data presented on the screen of the display unit 125 in the form of a vibration pattern or a voice signal by means of the text output unit 130 in step 470.

In the above-described method, the mobile terminal can output the text data selected according to the touch gesture made on the touchscreen 120. Although the description is directed to the text output mode in association with the e-book function, the present invention is not limited thereto. For example, the mobile terminal can output the text data included in an image through the above-described procedure. For this purpose, the mobile terminal first recognizes the text data included in the image and controls the text output unit 130 to output the text data recognized in accordance with the touch gesture detected on the touchscreen 120 in the form of a vibration pattern and a voice signal.

An exemplary mobile terminal and method for outputting text data according to the present invention is capable of selecting the text data with a length determined according to the touch gesture. Also, an exemplary mobile terminal and method for outputting text data according to the present invention allows the user to recognize the text data selected by a touch gesture in the form of a vibration or a voice output.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A data output method of a mobile terminal equipped with a touchscreen, the method comprising:
displaying text data on a screen in a text output mode;
detecting a touch gesture;
determining whether the touch gesture is followed by a movement; and
outputting, when the touch gesture is followed by the movement, a text selected among all displayed text data according to a direction of the movement.

2. The method of claim 1, wherein the determining of whether the touch gesture is followed by the movement comprises determining whether the direction of the movement is a horizontal direction, a diagonal direction, or a vertical direction.

3. The method of claim 2, wherein the outputting of the text selected among all displayed text data according to a direction of the movement comprises:
determining, when the direction of the movement is the horizontal direction, whether the touch gesture is released;
determining, when the touch gesture is released, a touch duration defined between a start time and an end time of the touch gesture; and
outputting, when the touch duration is less than a predetermined time window, a word including the text data mapped to a region to which the touch gesture is made.

4. The method of claim 3, further comprising outputting, when the touch duration is equal to or greater than the time window, a sentence including the text data mapped to the region to which the touch gesture made.

5. The method of claim 2, wherein the outputting of the text selected among all displayed text data according to a direction of the movement comprises:
determining, when the direction of the movement is the diagonal direction, whether the touch gesture is released; and
outputting, when the touch gesture is released, a paragraph including the text data mapped to a region to which the touch gesture is made.

6. The method of claim 5, further comprising determining, when the touch gesture is released, a touch duration defined between a start time and an end time of the touch gesture.

7. The method of claim 6, wherein the outputting of the paragraph including the text mapped to the region to which the touch gesture is made comprises outputting a number of paragraphs corresponding to the determined touch duration.

8. The method of claim 2, wherein the outputting of the text selected among the entire text data according to a direction of the movement comprises:
determining, when the direction of the movement is the vertical direction, whether the touch gesture is released; and
outputting, when the touch gesture is released, all data displayed on the screen.

9. The method of claim 1, further comprising determining and saving, when the text output mode is terminated, a position of the text data output according to the touch gesture.

10. A data output terminal comprising:
a touchscreen including a display unit for displaying text data in a text output mode and a touch sensor for detecting a touch gesture;
a control unit for determining whether the touch gesture is followed by a movement and for selecting a text according to a direction of the movement; and
a text output unit for outputting the text under the control of the control unit.

11. The data output terminal of claim 10, wherein the control unit determines whether the direction of the movement is a horizontal direction, a diagonal direction, or a vertical direction.

12. The data output terminal of claim 11, wherein the control unit determines, when the direction of the movement is the horizontal direction, whether the touch gesture is released, determines, when the touch gesture is released, a touch duration defined between a start time and an end time of the touch gesture, and outputs, when the touch duration is less than a predetermined time window, a word including the text data mapped to a region to which the touch gesture is made.

13. The data output terminal of claim 12, wherein the control unit outputs, when the touch duration is equal to or greater than the time window, a sentence including the text data mapped to the region to which the touch gesture made.

14. The data output terminal of claim 11, wherein the control unit determines, when the direction of the movement is the diagonal direction, whether the touch gesture is released, and outputs, when the touch gesture is released, a paragraph including the text data mapped to a region to which the touch gesture is made.

15. The data output terminal of claim 14, wherein the control unit, determines, when the touch gesture is released, a touch duration defined between a start time and an end time of the touch gesture.

16. The data output terminal of claim 15, wherein the control unit outputs a number of paragraphs corresponding to the determined touch duration.

17. The data output terminal of claim 11, wherein the control unit determines, when the direction of the movement is the vertical direction, whether the touch gesture is released, and outputs, when the touch gesture is released, all text data displayed on the screen.

18. The data output terminal of claim 10, wherein the control unit determines and saves, when the text output mode is terminated, a position of the text data output according to the touch gesture.
